(19) United States
(12) Patent Application Publication
(10) Pub. No.: US 2026/0292531 A1
(43) Pub. Date: Sep. 24, 2026

(54) MOBILITY-AWARE BEAMSWEEPING

(71) Applicant: T-Mobile USA, Inc., Bellevue, WA (US)

(72) Inventor: Al Duy Bui, Seattle, WA (US)

(21) Appl. No.: 19/088,483

(22) Filed: Mar. 24, 2025

(51) Int. Cl. H04W 16/28; H04W 36/00; H04W 36/14

(52) U.S. Cl. CPC H04W 16/28; H04W 36/00833; H04W 36/14

(57) ABSTRACT

Optimizing beamsweeping in wireless telecommunications networks for user equipment (UE) mobility reduces re-attachment latency and enhances overall network efficiency. Solutions disclosed herein configure beamsweeping operations to account for expected or predicted UE movement patterns within a network cell. A system can observe UE movement patterns through beam attachment sequences and can determine frequencies or expectancy scores for different patterns/sequences. Then, the system can improve a re-attachment beamsweeping for a UE currently attached to a given beam. The re-attachment beamsweeping can be configured based on an expectation that the UE will likely attach to a particular beam subsequent to its attachment to the given beam, based on the observed movement patterns. In an example, the re-attachment beamsweeping can begin from that particular beam or transmit the certain beam for a particular duration, thus facilitating an improved re-attachment process for the UE and improved transmission efficiency for the network node.

### BACKGROUND

Beamsweeping is a technique used in wireless telecommunications networks to enhance signal strength, improve throughput, and reduce interference by directing signals in specific directions. In a beamsweeping process, a base station transmits signals across different angles to cover an area and identify the optimal direction for communication with user equipment (UE). The UE measures the different beam signals and reports this information back to the base station. The UE and the base station can then select the best beam for communication. Optimization of beamsweeping can provide optimal signal quality and network performance.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a drawing that schematically illustrates beamsweeping operations between a network node and a UE, according to some example implementations.

FIG. 4 illustrates an example environment in which mobility-aware beamsweeping operations can be implemented, according to some example implementations.

FIG. 5 depicts an example of a data model used for providing beamsweeping operations based on observed UE movement patterns, according to some example implementations.

FIGS. 6-7 are flowcharts of example methods for mobility-aware beamsweeping, according to some example implementations.

FIG. 8 is a block diagram that illustrates an example of a computing system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present disclosure provides solutions for adapting beamsweeping in wireless telecommunications networks for UE mobility, for example, through beamsweeping configurations that track expected UE movement. Sequence and duration of different beams can be adjusted based on movement patterns of UEs observed over time. This mobility-aware beamsweeping can improve continuity of UE attachment (by facilitating re-attachment) and enhance transmission efficiency at network nodes.

Existing beamsweeping techniques focus on breadth of coverage with respect to space and time, and existing beamsweeping can be configured statically due to these goals. However, existing beamsweeping techniques are not optimized for different environments that might have high (and non-uniform) device density, frequent motion, and obstacles that affect signal propagation. For example, existing beamsweeping configurations often sweep each zone for the same amount of time without considering the likelihood of device presence, leading to slower attachment times and wasted power. Thus, existing beamsweeping systems fail to account for the dynamic movement of UEs, which can be widely observed due to certain geographic features (e.g., roadways, natural land features) constraining or biasing UE movement.

The present disclosure addresses these challenges through mobility-aware beamsweeping techniques that optimize the configuration of beam transmissions based on the expected movement patterns of UEs. For example, by predicting the movement of UEs and adjusting the beamsweeping sequence accordingly, the system can reduce the time it takes for UEs to re-attach to the network. A network node can expect that a UE will likely be best served by a particular beam after being attached to a current beam given observed movement patterns. Based on this expectation, the network node can adjust the subsequent beamsweeping transmission to emphasize the particular beam, thus facilitating an improved re-attachment of the UE (to the particular beam) in the event that its current beam attachment begins declining in quality.

The adjustment of beamsweeping configurations can be adapted continuously through continued observation of various UE movement patterns through the network cell. Expectancy frequencies or scores associated with different movement patterns (and by consequence, different beam attachment sequences/orders) can be adjusted based on respective occurrences. Therefore, the present solutions can adjust and tune beamsweeping configurations to track changes to common UE movement patterns.

### Example Wireless Communications Systems

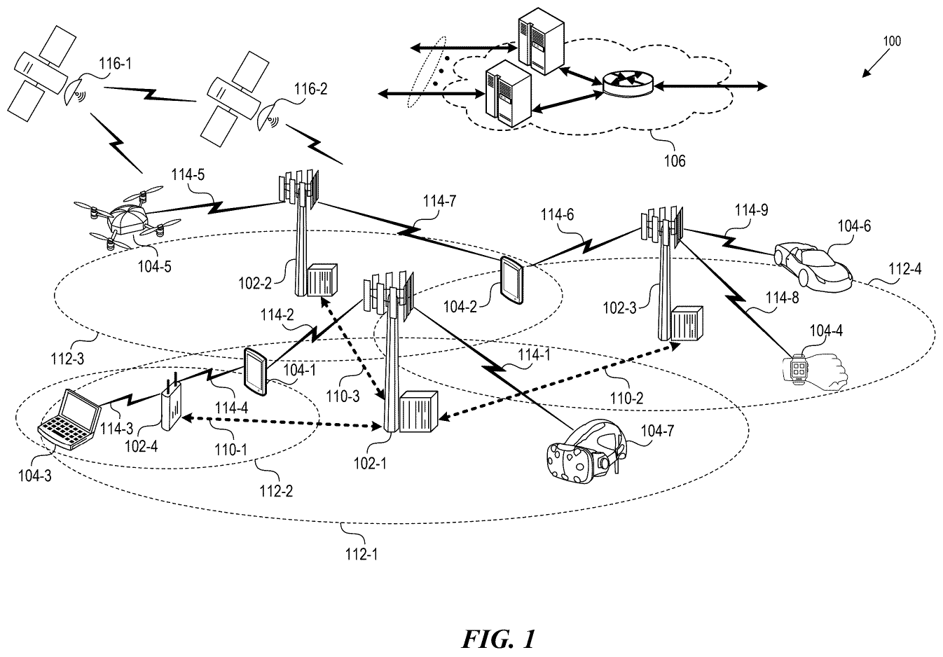

FIG. 1 is a block diagram that illustrates a wireless telecommunication network 100 (“network 100”) in which aspects of the disclosed technology are incorporated.

For example, components of the illustrated network can determine expected UE movement patterns and adjust beamsweeping configurations to track those expected UE movement patterns.

The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point. In some implementations, these base stations or NANs can multiple transmission-reception points (TRPs) and can be configured to transmit and receive signals via multiple beams.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc. These wireless devices can be mobile devices whose locations change over time.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Example Core Network Systems

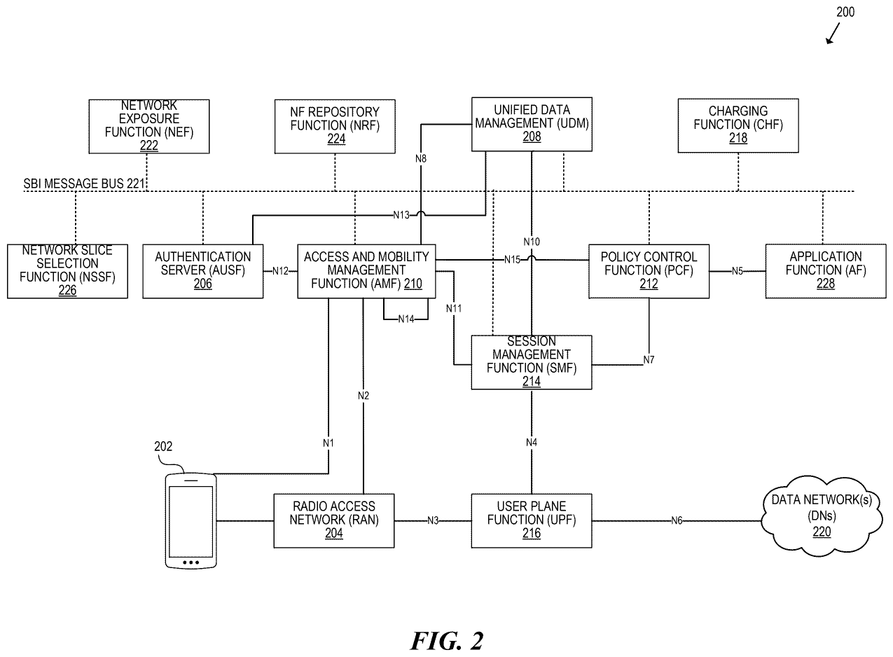

FIG. 2 is a block diagram that illustrates an architecture 200 including 5G core network functions (NFs) that can implement aspects of the present technology. For example, information related to different and expected UE movement patterns can be stored and updated via one or more core network functions.

A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has predetermined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Example Implementations of Mobility-Aware Beamsweeping

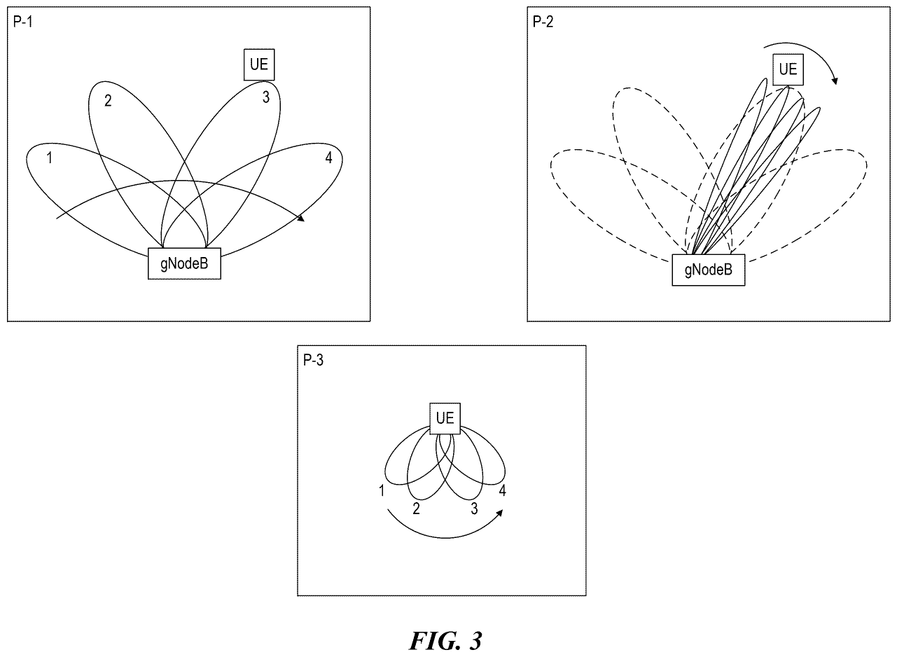

Implementations described herein relate to improving beamsweeping to account for UE mobility. FIG. 3 schematically illustrates the multi-step process of attachment and beam refinement for beamsweeping generally, which can be divided into three procedures: P-1, P-2, and P-3. In procedure P-1, a base station (e.g., gNodeB) sweeps multiple zones using relatively wide beams, which can carry reference signals (e.g., Synchronization Signal Block (SSB), Channel State Information-Reference Signal (CSI-RS)). This initial acquisition focuses on selecting the best beam pair based on measurements generated by the UE that detects or receives the beams (e.g., Reference Signal Received Power (RSRP) measurements). In some examples, the beams used during the P-1 procedure are relatively wide and thus may not be optimal for wireless communications. In FIG. 3, four beams are depicted, but it is understood that there can be more or fewer beams. As shown, a user equipment (UE) is located generally in the direction of beam three.

Further, the sweeping aspect of beamsweeping can be observed by the sequential or ordered transmission of the beams. In the illustrated example, for instance, beam one can be transmitted first, followed by beam two, beam three, and beam four individually. The sequential and individual transmission of beams can manage interference between beams and budget the base station's power consumption.

In procedure P-2, the beam transmitted by the base station is further refined within beam three. The receive beam remains fixed while the transmit beam is transmitted in finer directions (e.g., over narrow angles) within the zone of the beam selected in P-1. The UE again measures properties of the beams, which are used to select the best transmit beam.

Procedure P-3 involves receive-end beam refinement, in which the UE performs its own beamsweeping to optimize its connection with the base station while the transmit beam remains fixed. Reference signals are sent with the same transmit beam, and the best receive beam is selected based on measurements of receive beams.

Thus, beamsweeping can include multiple stages on different resolutions (e.g., course or fine beam selection). Different implementations of beamsweeping can include more or fewer stages at different resolutions. The solutions disclosed herein can be applied in any one or more of multiple beamsweeping stages in order to improve beam selection therein.

Subsequent to attaching to a selected beam, the signal received by the UE can degrade in quality. Based on the continuous monitoring and reporting of signal measurements, the UE can trigger a re-attachment process. For instance, the UE can send measurement reports to the base station over time while attached and using a given beam, and certain signal measurements can decrease below respective thresholds. The base station can then perform another beamsweeping operation so that the base station and the UE can attempt re-attachment on another beam. In some instances, the base station can also determine whether to initiate a handover to a different cell. This re-attachment process can facilitate continuous and reliable communication as the UE moves through the network. However, in existing systems, the beamsweeping operation is simply repeated (e.g., performing each of procedures P-1, P-2, P-3 in some implementations) and is not adapted based on any expectation or prediction for where the UE is moving. In particular, adhering to a statically configured beam transmission sequence/order and beam durations may introduce latency and transmission inefficiencies.

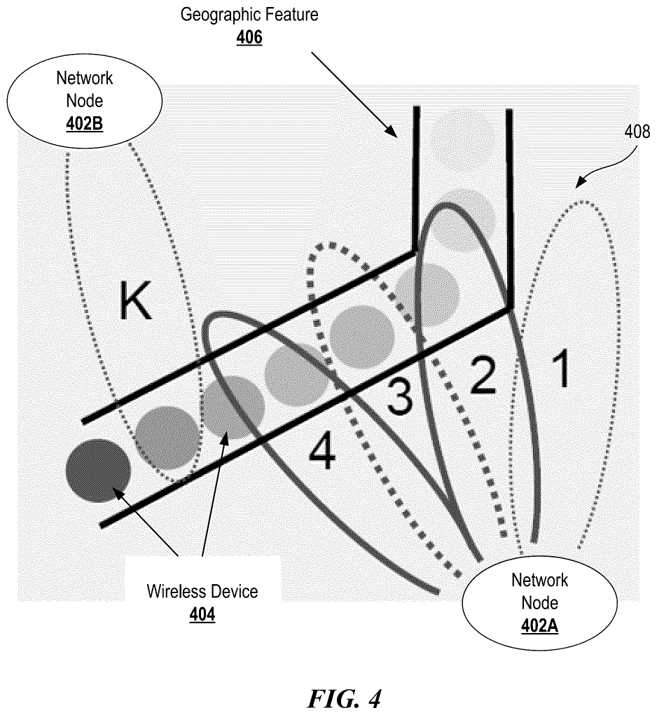

FIG. 4 illustrates an example environment in which mobility-aware beamsweeping operations can be implemented. The example environment includes a first network node 402A configured to facilitate access for UEs such as wireless device 404 to a telecommunications network. In doing so, the first network node 402A may provide a network cell of the telecommunications network. In the illustrated example, the network cell covers a geographic area that includes a geographic feature 406 that biases, constrains, or guides movements of UEs generally. In the example illustration, the geographic feature 406 causes UEs to generally travel down and to the left of the page. In one example, the geographic feature 406 is a one-way road along which UE users travel across the network cell. Other examples of geographic features that can bias UE movement or mobility can include natural land features (e.g., valleys, mountains, rivers), infrastructure (e.g., buildings, bridges), legal or artificial restrictions (e.g., approved flight routes, geofences, no-fly zones), and/or the like.

The first network node 402A is configured for transmission of multiple beams 408 to which UEs in the network cell, including wireless device 404, can attach. When performing beamsweeping for UE searching and attachment, the first network node 402A can be configured to transmit the beams 408 in a default order. In the illustrated example, for instance, the first network node 402A can transmit beam four followed by beam three followed by beam two followed by beam one, thus sweeping beam transmissions in a clockwise (or left-to-right) direction across the network cell. In some implementations, the beams can be configured to cover certain zones, according to the implementations described in U.S. patent application Ser. No. 18/990,913 titled “ENVIRONMENT-AWARE BEAMSWEEPING” and filed on Dec. 20, 2024. The entirety of the contents of the aforementioned application are incorporated herein by reference.

In order to provide UE mobility awareness, UE movement patterns can be observed, as biased by geographic feature 406 for example, over time. In the illustrated example, more UEs may move in a direction towards the bottom left of the page due to the geographic feature 406, compared to other possible directions. This is then manifested and observed in the sequence or order of beams with which these UEs attach and re-attached. For instance, it can be observed that more UEs use beam two followed by beam three followed by beam four, compared to other orders such as beam four followed by beam three followed by beam two. Such a commonly observed beam sequence/order tracks the movement pattern influenced by the geographic feature 406 for most UEs.

UE mobility can be observed further with handovers to other network nodes. For instance, it can also be observed in the common beam sequence that UEs are frequently handed over subsequent to their attachment to beam four, to a beam or network cell provided by a second network node 402B.

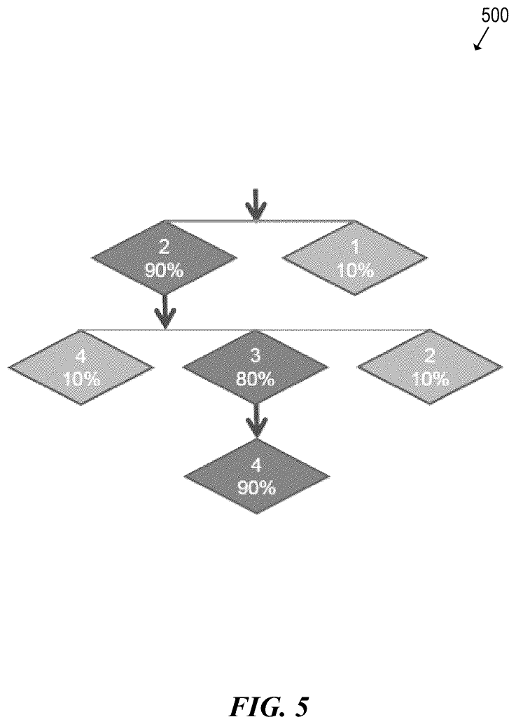

FIG. 5 illustrates an example of a data model 500 that can be used to track these observations of UE mobility or movement patterns. In some implementations, the data model 500 is configured to identify different beam attachment sequences or orders, which suggest different UE movement patterns. In the illustrated example, the data model 500 is a decision tree that identifies one or more other possible beams to which a wireless device might attach to after being attached to a given beam. For instance, the data model 500 identifies beams two, three, and four as possible attachment candidates subsequent to an attachment to beam two. It will be understood that some beam sequences are not shown for ease and clarity of description.

Beyond identifying different beam orders, the data model 500 is further configured to associate observation frequencies with the different beam orders. In doing so, the data model 500 can be used to identify more frequent or common beam orders, which can result from the UE mobility being biased by geographic features in the area. The observation frequencies for different beam orders can then be used to measure expectancy or likelihood of those beam orders given a beam attachment.

In the illustrated example, for instance, the data model 500 indicates that observed wireless devices more frequently attach to beam three immediately following an attachment to beam two than to beams four or two. The data model 500 also indicates that wireless devices frequently attach to beam four subsequent to an attachment to beam three. Thus, the data model 500 indicates a frequent UE movement pattern of traveling from a zone corresponding to beam two to a zone corresponding to beam three to a zone corresponding to beam four. In some implementations, the data model 500 also indicates a handover as a possible event after an attachment to a given beam, and a handover can represent an end of a possible movement pattern within the network cell.

In some implementations, the data model 500 is a linked list, a decision tree, or other data structure that is able to link possible subsequent beams to a given beam and associate observed frequencies with each beam possibility.

In some implementations, the data model 500 is continuously updated over time based on the frequencies that certain beam attachment sequences are observed. Given the current state of the illustrated example, each instance that a UE re-attaches to beam three subsequent to being attached to beam two can result in the observation frequency associated with such sequence increasing by an amount (e.g., 80% to 84%) and the other frequencies (“2”->“2”, or “2”->“4”) decreasing by an amount (e.g., 10% to 8% each).

In some implementations, the frequencies associated with different sequencies may be scores, normalized values, or other representations, rather than an actual frequency of observation. Thus, the adjustment of an observation frequency may not correlate exactly with the statistical percentage of observation but instead may be a parameter controlling an elasticity, sensitivity, or inertia of the model. Thus, an observation frequency (e.g., 80% for beam “3” following beam “2”) may be adjusted by an amount that is pre-determined by a parameter controlling how sensitive the model is with solidifying certain UE movement patterns and adapting to newly observed or changed UE movement patterns. In some implementations, the adjustment amount can be proportional to or based on a current observation frequency or score. For instance, observed occurrence of a beam order associated with a score of 80% is adjusted to 82%, while observed occurrence of a beam order associate with a score of 40% is adjusted to 50%.

Returning to FIG. 4, the first network node 404A can adapt its beamsweeping configuration in order to provide the beams in a sequence that tracks frequent or likely UE movements, so that later beamsweeping operations can be adapted for the UEs in the network cell. In some implementations, the first network node 404A can adjust its beamsweeping configuration from its default sequence of beam four->beam three->beam two->beam one to a new or modified sequence of beam one->beam two->beam three->beam four based on frequent UE movements indicated by the data model 500.

Generally, a new beamsweeping configuration determined based on observed UE movements can define a new order or sequence of beam transmissions, define new durations for each beam transmission, and/or define a new starting beam. In some implementations, a new beamsweeping configuration with a new beam order/sequence can improve an initial attachment of the wireless device 404 with the first network node 402A by having the beam transmission follow the wireless device's expected movement.

In some implementations, a new beamsweeping configuration improves a re-attachment of the wireless device 404 as it moves through different zones covered by the different beams transmitted by the first network node 402A. For instance, the new beamsweeping configuration can include one or more rules that defines a starting beam when a beamsweeping operation for re-attachment is triggered. Based on the data model 500 indicating that beam three attachment likely follows beam two attachment, the first network node 402A can begin a beamsweeping operation beginning from beam three when triggered by the wireless device 404 losing signal from beam one. In doing so, the wireless device 404 can collect measurements from beam three and attach to beam three quicker. Thus, a re-attachment latency for the wireless device 404 is reduced based on a likely “next” beam for the wireless device 404 being transmitted earlier.

Alternatively, or additionally, new durations can be assigned to beam transmissions to efficiently manage the power consumption and usage of the first network node 402A. For instance, because the data model 500 suggests that beam three attachment likely follows beam two attachment, then the triggered beamsweeping operation for re-attachment can increase a duration of beam three's transmission and decrease the durations of other beams. Doing so allows conservation or improved allocation of transmission power, as beams unlikely to be used by wireless device 404 because of its movement path/pattern are not transmitted for as long. In some embodiments, a transmit power associated with each beam transmission can also be modified or adjusted according to the likely movement of the wireless device. Taking again the example in which beam three attachment likely follows beam two attachment, the triggered beamsweeping operation for re-attachment can increase a transmit power associated with beam three while maintaining or reducing transmit powers for the other beams.

The first network node 402A can also preemptively prepare for handovers that likely follow a given beam attachment. In some implementations, the first network node 402A transmits an indication to the wireless device 404 when the wireless device 404 loses signal quality with beam four that the wireless device 404 can begin searching for other network cells (e.g., a network cell provided by second network node 402B). The first network node 402A may locally de-register wireless device 404. In some implementations, the first network node 402A can communicate with the second network node 402B regarding the possible handover.

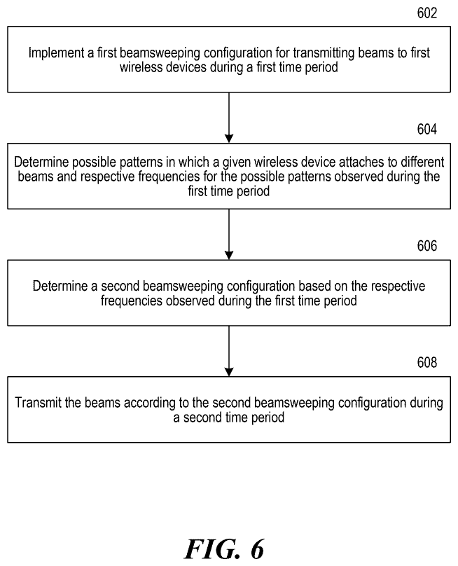

FIG. 6 is a flowchart including example operations for mobility-aware beamsweeping. In some implementations, the example operations are implemented or performed by a network node, such as a base station (e.g., a gNodeB).

At 602, the network node implements a first beamsweeping configuration for transmitting beams to first wireless devices during a first time period. The first beamsweeping configuration defines parameters for the network node transmitting a plurality of beams across the network cell, such as an angle range for each beam, a transmission duration for each beam, and transmission sequence for the beams. The plurality of beams are configured to cover a particular geographic area selected based on historical attachment locations, for example, based on environmentally-aware techniques as described in U.S. patent application Ser. No. 18/990,913.

At 604, the network node determines possible patterns in which a given wireless device attaches to different beams and respective frequencies for the possible patterns observed during the first time period. The network node generates or updates a data model, such as a decision tree, a linked list, and/or the like, configured to identify different possible patterns of the plurality of beams for serving a given wireless device. The data model associates respective observation frequencies with the different possible patterns, including patterns that correspond to handovers to different network nodes. The frequencies associated with different beam patterns are adjusted based on each observed occurrence of a beam pattern during the first time period.

At 606, the network node determines a second beamsweeping configuration based on the respective frequencies observed during the first time period. The second beamsweeping configuration modifies at least one of the parameters of the first beamsweeping configuration according to the respective observation frequencies included in the data model. This may involve defining a new order in which the plurality of beams are transmitted, starting from a particular beam identified by the data model as being likely to facilitate attachment, or adjusting transmission durations for certain beams to efficiently allocate or conserve power.

At 608, the network node transmits the beams according to the second beamsweeping configuration during a second time period. Based on this second beamsweeping, the network node can cause the wireless device to re-attach via a different beam, or cause the wireless device to prepare for a handover to another network node.

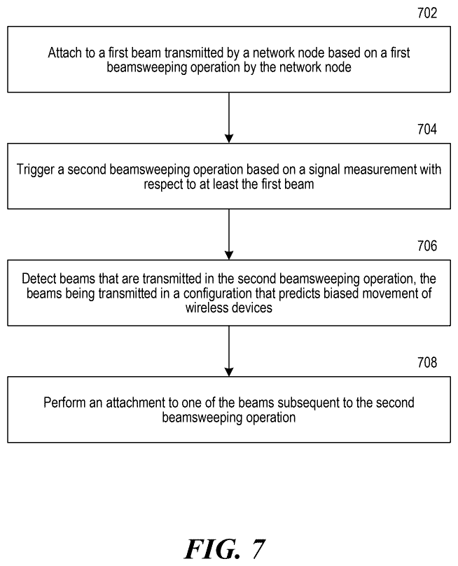

FIG. 7 is a flowchart including example operations for mobility-aware beamsweeping. In some implementations, the example operations are implemented or performed by a wireless device or a UE. The wireless device can implement or perform the operations in order to leverage beamsweeping that is adapted to the wireless device's expected movements.

At 702, the wireless device attaches to a first beam transmitted by a network node based on a first beamsweeping operation by the network node. The wireless device attaches to the first beam based on a first signal measurement corresponding to the first beam. The wireless device attaches to the first beam while positioned at a first location.

At 704, the wireless device triggers a second beamsweeping operation based on a signal measurement with respect to at least the first beam. The second beamsweeping operation is triggered by a second signal measurement with respect to the first beam. The second signal measurement may indicate that a signal quality with the first beam has declined. In some examples, the signal quality with the first beam would have declined due to movement of the wireless device away from the first location, or away from a zone or area covered by the first beam.

At 706, the wireless device detects beams that are transmitted in the second beamsweeping operation by the network node. The beams detected by the wireless device are transmitted in a configuration that predicts biased movement of wireless devices. Thus, the beams detected by the wireless device may be propagated through the network cell in a different order than during the first beamsweeping operation. The beams in the second beamsweeping operations are transmitted with different respective durations than during the first beamsweeping operation.

At 708, the wireless device performs an attachment to one of the beams subsequent to the second beamsweeping operation. The wireless device performs a re-attachment based on a third signal measurement of the beams received during the second beamsweeping operation.

### Example Computing Systems

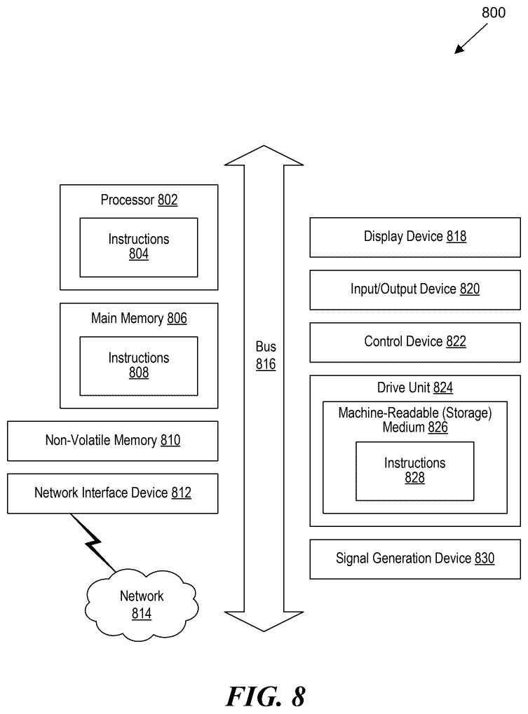

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a video display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computing system 800 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 800. In some implementations, the computer system 800 can be an embedded computer system, a system-on-chip (SOC), a single-board computer system (SBC), or a distributed system such as a mesh of computer systems, or it can include one or more cloud components in one or more networks. Where appropriate, one or more computer systems 800 can perform operations in real time, in near real time, or in batch mode.

The network interface device 812 enables the computing system 800 to mediate data in a network 814 with an entity that is external to the computing system 800 through any communication protocol supported by the computing system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computing system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computing system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A system for improving beamsweeping in a wireless telecommunications network, the system comprising:
at least one processor; and
at least one memory storing instructions that, when executed by the at least one processor, cause the system to implement operations comprising:
at a network node providing a network cell in which at least one geographic feature that biases movement of wireless devices through the network cell is located, implementing a first beamsweeping configuration that defines parameters for the network node transmitting a plurality of reference signal beams across the network cell,
wherein the parameters include an angle range and a transmission duration for each of the plurality of reference signal beams and a transmission sequence of the plurality of reference signal beams;
causing the network node to transmit the plurality of reference signal beams across the network cell according to the first beamsweeping configuration for a first time period,
wherein the network node serves at least one first wireless device based on transmitting the plurality of reference signal beams for attachment by the at least one first wireless device during the first time period;
generating or updating a data model configured to identify different possible patterns of the plurality of reference signal beams for serving a given wireless device over a course of the given wireless device traversing the network cell,
wherein the data model is generated or updated to associate respective observation frequencies with the different possible patterns according to the attachment by the at least one first wireless device to the plurality of reference signal beams during the first time period,
wherein at least one of the different possible patterns corresponds to the movement of wireless devices through the network cell that is biased by the at least one geographic feature;
determining a second beamsweeping configuration based on modifying at least one of the parameters of the first beamsweeping configuration according to the respective observation frequencies included in the data model; and
causing the network node to perform transmission of the plurality of reference signal beams according to the second beamsweeping configuration for a second wireless device that is moving through the network cell,
wherein a re-attachment latency of the second wireless device is reduced based on the second beamsweeping configuration predicting a movement of the second wireless device being biased based on the respective observation frequencies included in the data model.

2. The system of claim 1, wherein the data model is a decision tree that defines the different possible patterns of the plurality of reference signal beams based on linking, to a given reference signal beam, one or more other reference signal beams to which the given wireless device is expected to attach based on a movement of the given wireless device.

3. The system of claim 1, wherein at least one of the different possible patterns identified by the data model includes a handover to a different network node subsequent to attachment with one of the plurality of reference signal beams.

4. The system of claim 1, wherein causing the network node to perform transmission of the plurality of reference signal beams according to the second beamsweeping configuration for the second wireless device comprises:
predicting, subsequent to a first attachment by the second wireless device to a first one of the plurality of reference signal beams, a second one of the plurality of reference signal beams to which the second wireless device will attach, based on the respective observation frequencies included in the data model; and
performing transmission of the second one of the plurality of reference signal beams or a handover of the second wireless device.

5. The system of claim 1, wherein causing the network node to perform transmission of the plurality of reference signal beams according to the second beamsweeping configuration for the second wireless device comprises:
predicting that a handover is subsequent to a first attachment by the second wireless device to a first one of the plurality of reference signal beams; based on the respective observation frequencies included in the data model; and
transmitting an indication to the second wireless device to cause the second wireless device to begin searching for additional network nodes.

6. The system of claim 5, wherein causing the network node to perform transmission according to the second beamsweeping configuration further comprises:
locally de-registering, at the network node, the second wireless device.

7. The system of claim 1, wherein the plurality of reference signal beams are configured to cover a particular geographic area selected based on historical attachment locations.

8. A method for improving beamsweeping in a wireless telecommunications network, comprising:
generating a data model configured to identify possible beam sequences of a plurality of beams for serving a given wireless device that is moving across a network cell provided by a network node,
wherein the network cell encompasses at least one geographic feature that biases movement of wireless devices through the network cell;
wherein at least one of the possible beam sequences corresponds to the movement of wireless devices through the network cell that is biased by the at least one geographic feature;
updating the data model with respective observation frequencies associated with the possible beam sequences based on attachments by at least one first wireless device to the plurality of beams being transmitted by the network node during a first time period,
wherein the network node transmits the plurality of beams during the first time period according to a first beamsweeping configuration;
determining a second beamsweeping configuration based on the respective observation frequencies included in the data model; and
for a second wireless device being served by the network node subsequent to the first time period, causing the network node to perform a transmission of the plurality of beams according to the second beamsweeping configuration,
wherein a re-attachment latency of the second wireless device is reduced based on the second beamsweeping configuration predicting a movement of the second wireless device being biased based on the respective observation frequencies included in the data model.

9. The method of claim 8, wherein the data model is a decision tree that defines the possible beam sequences based on linking, to a given beam, one or more other beams to which the given wireless device is expected to attach based on a movement of the given wireless device.

10. The method of claim 8, wherein the second beamsweeping configuration defines, given a presently attached beam, a re-transmission of a particular beam likely for attachment subsequent to the presently attached beam according to the data model, prior to a re-transmission of each of the plurality of beams in an order.

11. The method of claim 8, wherein the second beamsweeping configuration defines a new order in which the plurality of beams are re-transmitted, the new order starting from a particular beam identified by the data model as being likely to facilitate attachment subsequent to a presently attached beam.

12. The method of claim 8, wherein the second beamsweeping configuration defines, given a presently attached beam, a re-transmission of the plurality of beams, in which a transmission duration is increased for a particular beam identified by the data model as being likely to facilitate attachment subsequent to the presently attached beam.

13. The method of claim 8, wherein the data model identifies at least one possible beam sequence that includes a handover to a different network node.

14. The method of claim 8, wherein the plurality of beams are configured to cover a particular geographic area selected based on historical attachment locations.

15. At least one non-transitory computer-readable medium storing instructions that, when executed by at least one processor, cause the at least one processor to perform operations comprising:
generating a data model configured to identify possible beam sequences of a plurality of beams for serving a given wireless device that is moving across a network cell provided by a network node,
wherein the network cell encompasses at least one geographic feature that biases movement of wireless devices through the network cell;
wherein at least one of the possible beam sequences corresponds to the movement of wireless devices through the network cell that is biased by the at least one geographic feature;
updating the data model with respective observation frequencies associated with the possible beam sequences based on attachments by at least one first wireless device to the plurality of beams being transmitted by the network node during a first time period,
wherein the network node transmits the plurality of beams during the first time period according to a first beamsweeping configuration;
determining a second beamsweeping configuration based on the respective observation frequencies included in the data model; and
for a second wireless device being served by the network node subsequent to the first time period, causing the network node to perform a transmission of the plurality of beams according to the second beamsweeping configuration,
wherein a re-attachment latency of the second wireless device is reduced based on the second beamsweeping configuration predicting a movement of the second wireless device being biased based on the respective observation frequencies included in the data model.

16. The at least one non-transitory computer-readable medium of claim 15, wherein the data model is a decision tree that defines the possible beam sequences based on linking, to a given beam, one or more other beams to which the given wireless device is expected to attach based on a movement of the given wireless device.

17. The at least one non-transitory computer-readable medium of claim 15, wherein the second beamsweeping configuration defines, given a presently attached beam, a re-transmission of a particular beam likely for attachment subsequent to the presently attached beam according to the data model, prior to a re-transmission of each of the plurality of beams in an order.

18. The at least one non-transitory computer-readable medium of claim 15, wherein the second beamsweeping configuration defines a new order in which the plurality of beams are re-transmitted, the new order starting from a particular beam identified by the data model as being likely to facilitate attachment subsequent to a presently attached beam.

19. The at least one non-transitory computer-readable medium of claim 15, wherein the second beamsweeping configuration defines, given a presently attached beam, a re-transmission of the plurality of beams, in which a transmission duration is increased for a particular beam identified by the data model as being likely to facilitate attachment subsequent to the presently attached beam.

20. The at least one non-transitory computer-readable medium of claim 15, wherein the data model identifies at least one possible beam sequence that includes a handover to a different network node.
